(19) United States
(12) Patent Application Publication
(10) Pub. No.: US 2023/0321985 A1
(43) Pub. Date: Oct. 12, 2023

(54) PRINTING LIQUID COLLECTION

(71) Applicant: Hewlett-Packard Development Company, L.P., Spring, TX (US)

(72) Inventors: Marcos ARMIÑANA TERRASA, Sant Cugat del Valles (ES); Ignasi BONJOCH ROMA, Sant Cugat del Valles (ES); Diego LÓPEZ UBIETO, Sant Cugat del Valles (ES)

(73) Assignee: Hewlett-Packard Development Company, L.P., Spring, TX (US)

(21) Appl. No.: 17/995,579

(22) PCT Filed: Apr. 6, 2020
(86) PCT No.: PCT/US2020/026882

§ 371 Date: Oct. 5, 2022

(51) Int. Cl. B41J 2/17

(52) U.S. Cl. CPC B41J 2/1721; B41J 2002/1742

(57) ABSTRACT

Disclosed herein are apparatus and methods for collection printing liquid e.g. ink. A printing liquid collection apparatus comprises a collection tray comprising a printing liquid droplet collection surface to capture printing liquid droplets produced during application of a printing liquid to a porous substrate; and a printing liquid removal element to receive the captured printing liquid from the collection tray and transport the captured printing liquid to a waste printing liquid container.

Managing printing liquid waste produced during a printing process can be challenging. For example, printing on a porous substrate can produce printing liquid waste.

Example implementations will now be described with reference to the accompanying drawings in which:

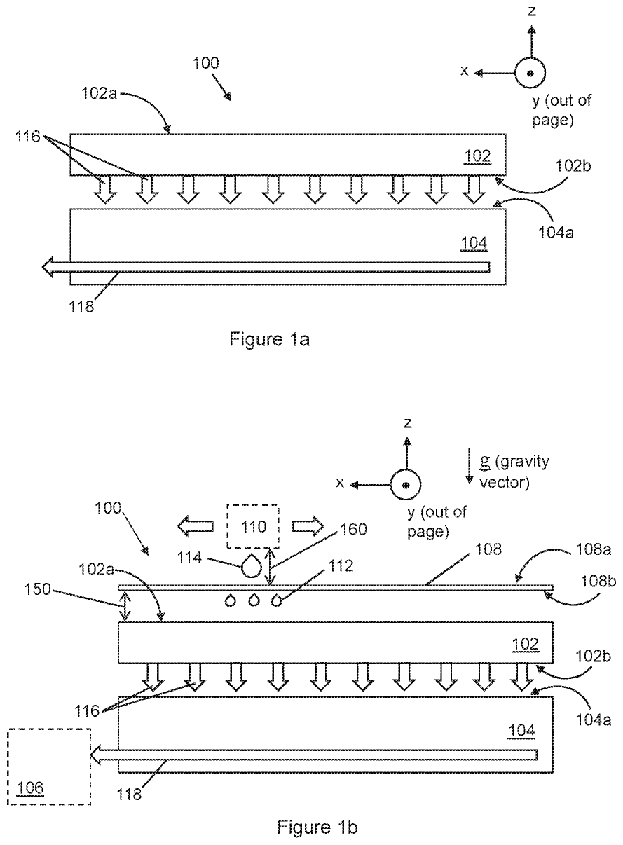

FIGS. 1a-b show printing liquid collection apparatus, according to example implementations;

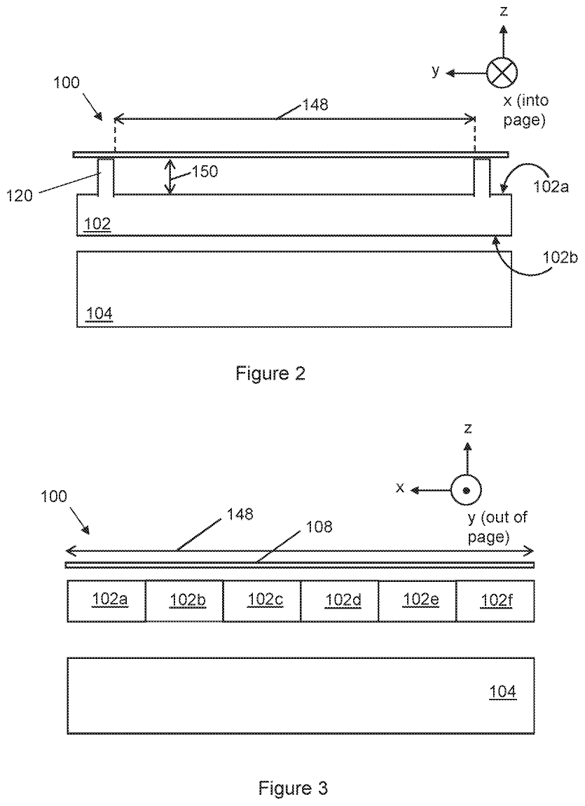

FIG. 2 illustrates a collection tray according to example implementations;

FIG. 3 shows a composite collection tray according to example implementations;

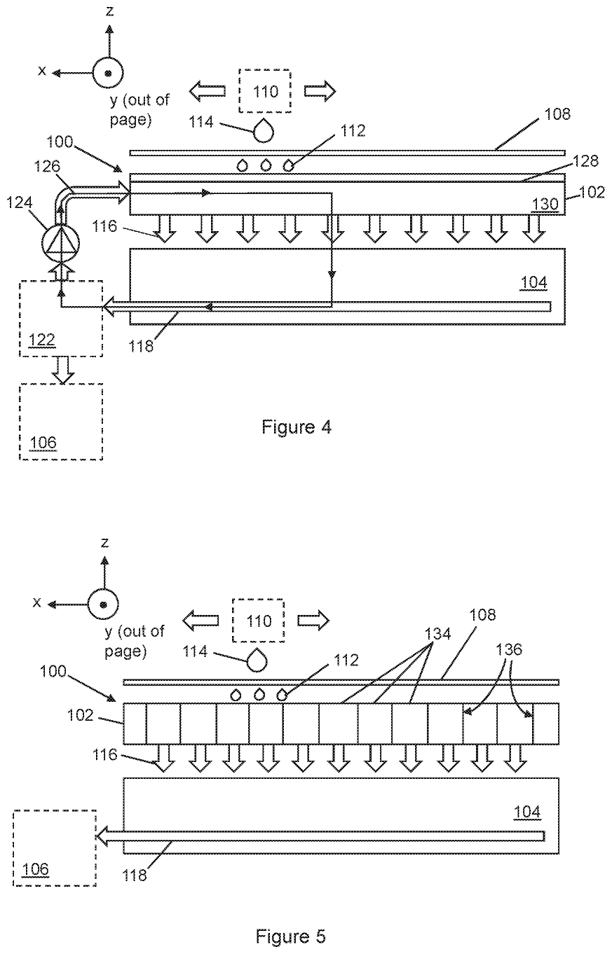

FIG. 4 shows a printing liquid collection apparatus comprising a closed loop liquid conduit according to example implementations;

FIG. 5 shows a printing liquid collection apparatus comprising a cellular collection tray according to example implementations;

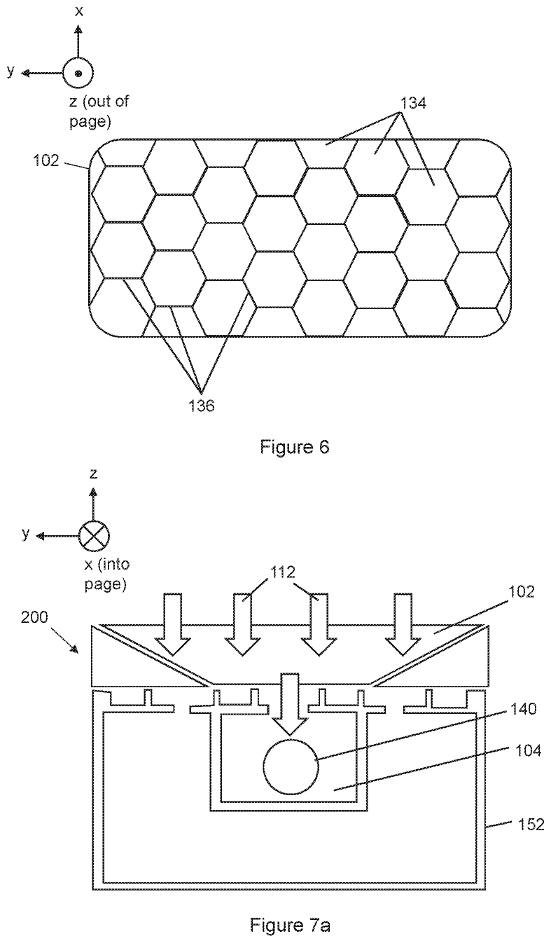

FIG. 6 shows a plan view of an example cellular collection tray according to example implementations;

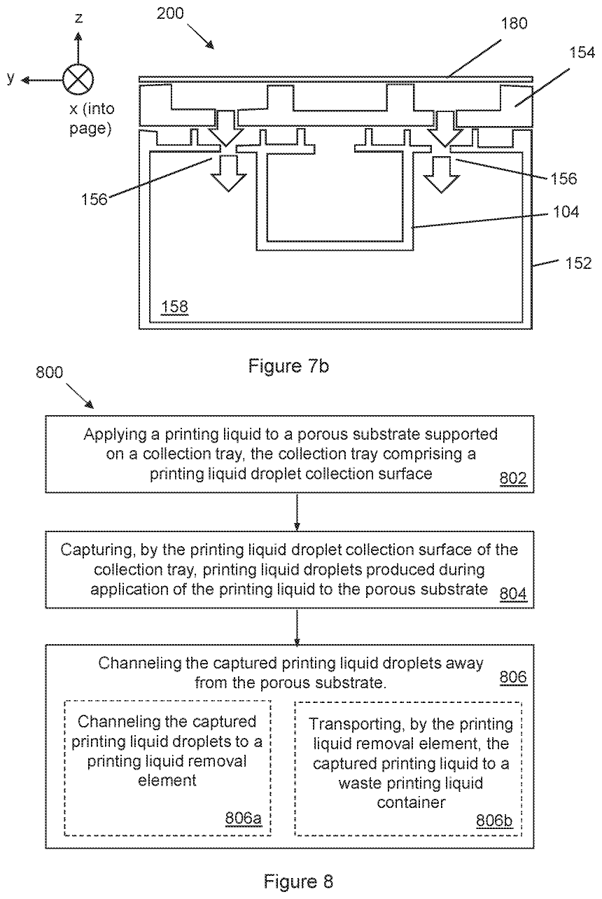

FIGS. 7a-7b show example printing apparatuses comprising a support beam according to example implementations; and

FIG. 8 shows an example method of according to example implementations.

Printing onto a porous substrate can generate waste printing liquid (e.g. ink) which has passed through the substrate from the printed side to the back side of the porous substrate. This waste printing liquid should be removed from the print area.

Some examples of handling waste printing liquid use absorbent materials such as foams, sponges or blankets, to soak up excess printing liquid (such solutions may be termed “foam-based” systems). The capacity of these systems is limited to the operative life of the absorbing material (porosity and capacity to absorb the wasted ink). The absorbent materials should be replaced periodically because they become saturated or develop a crust of waste printing liquid on the surface preventing further printing liquid absorption. Replacement of the absorbent materials is an additional cost to the printer owner and it takes time to replace the used material with fresh absorbent material. Not all printing liquids can be easily absorbed by a foam or other absorbent material, and so the lifetime of the absorbent material may depend the kind of printing liquid used and its viscosity. Some highly viscous inks, for example, such as latex inks, may not easily penetrate inside the foam, but instead generate a crust on top of the foam, which ends up creating ink buildups leading to replacement of the foam.

In industrial printers (i.e. printers having large print zones) using foam-based waste printing liquid apparatus, foams may be included in modules that the user may mount each module onto the print-zone. This operation may use an auxiliary sub-system to raise the machine carriage from the printing position to the mounting position.

Some examples of handling waste printing liquid use sticky-belt systems in which the substrate is held on a sticky belt with adhesive, and the belt is continuously washed down with high-flow water. Such systems may be very intensive in water consumption. Such systems may also present environmental, sustainability and regulatory issues due to high water volume consumption.

Some examples of handling waste printing liquid use a gutter system consisting of a simple gutter below the porous substrate. The gutter has a slight slope such that printing liquid waste should flow under gravity to a drainage tube. However, issues can arise as printing liquid waste gets clogged inside the gutter and/or in the tube. The more viscous a printing liquid is, the more clogging issues may arise. Moreover, such systems may not be versatile enough to print onto non-porous materials such as transfer papers or banners.

Moreover, printing onto porous substrates may generate printing liquid aerosol droplets/particles inside the printer. An aerosol may be defined as a suspension or presence of fine printing liquid droplets in air (e.g. in the space under the porous substrate, or between the printing substrate and the collection tray). Such aerosol droplets may leave unwanted marks on the printing area/plot, may contribute to dirtying the printer and surrounding area, and may accumulate and cause early failures in various optical and electrical components of the printing machine. Aerosol droplets may be considered as droplets having a size (diameter) of less than 15 μm in some examples, or less than 30 μm in some examples. Aerosol droplets may be considered as droplets having a volume of between 2-3 picolitres (pl) in some examples.

Apparatus disclosed herein may address one or more of the issues discussed herein. Certain examples disclosed herein may operate on an industrial scale (e.g. large format printers such for printing large format textiles and signage, for example). Certain examples disclosed herein may handle highly viscous printing liquid, for example to allow for removal of highly viscous ink waste from the print zone. Certain examples disclosed herein may handle different viscosities of printing liquid, and as such are suitable for use in handling different ink types, from less viscous inks such as dye-sublimation inks to highly viscous inks such as latex inks.

Certain examples disclosed herein do not use consumable parts such as foams, which aids environmental sustainability and productivity. Certain examples disclosed herein may be implemented in printers which allow for the collection tray position underneath the substrate and for use with porous substrates, to be replaced with an apparatus (e.g. a platen) for use with non-porous substrates, to provide a versatile printing machine capable of printing on both porous and non-porous substrates.

Certain examples disclosed herein which use a transport liquid to aid removal of waste printing liquid may use a closed loop transport liquid recirculation circuit, to reduce the transport liquid (e.g. water) consumption of the system compared with a sticky-belt system.

FIGS. 1a-1b show a schematic side view of a printing liquid collection apparatus according to example implementations. FIG. 1a illustrates a printing liquid collection apparatus 100 comprising a collection tray 102 and a printing liquid removal element 104. The collection tray 102 and a printing liquid removal element 104 may each be considered to be tray-like with a small depth dimension (in the z direction) compared with a long length (in the x direction, which may be the scan axis defining the movement of the print head 110 back and forth) and/or width dimension (in the y direction, which may be the substrate advance axis defining the direction of movement of the substrate 108). The collection tray 102 comprises a printing liquid droplet collection surface 102a to capture printing liquid droplets produced during application of a printing liquid to a porous substrate. The printing liquid removal element 104 is to receive the captured printing liquid 116 from the collection tray 102 and transport the captured printing liquid 118 to a waste printing liquid container.

FIG. 1b schematically shows the apparatus of FIG. 1a used during a printing process. A print head 110 may move back and forth along the print zone depositing/applying printing liquid 114 onto a porous substrate 108. Excess printing liquid 112 which has passed through the porous substrate 108 is collected in the collection tray 102 at the printing liquid droplet collection surface 102a, which captures these printing liquid droplets 112. The printing liquid removal element 104 receives the captured printing liquid 116 from the collection tray 102 and transports the captured printing liquid 118 to a waste printing liquid container 106.

In the examples of FIGS. 1a and 1b, the collection tray 102 of the printing liquid collection apparatus 100 is located between the porous substrate 108 and the printing liquid removal element 104 during application of the printing liquid 114 to the porous substrate 108. The collection tray 102 is located to receive the printing liquid droplets 112 at a first surface 102a of the collection tray 102, from a second surface 108b of the porous substrate 108, during application of the printing liquid 114 to a first surface 108a of the porous substrate 108. The first surface of the porous substrate 108a is opposite the second surface of the porous substrate 108b. The printing liquid removal element 104 is to receive the captured printing liquid 116 from a second surface 102b of the collection tray 102. The first surface 102a of the collection tray 102 is opposite the second surface 102b of the collection tray 102.

In examples such as that of FIG. 4 in which the collection tray comprises a transport liquid, the first surface 102a (in the plane of the collection tray 102 and perpendicular to the z direction as illustrated) of the collection tray 102 may also be, or at least be co-planar with, the printing liquid droplet collection surface. In examples such as that of FIG. 5 in which the collection tray comprises a plurality of cells, the printing liquid droplet collection surface of the collection tray 102 may be the cell walls, which may not be in the plane of the collection tray 102 and may not be perpendicular to the z direction as shown. The cell walls may be a different surface to the first surface 102a of the collection tray 102.

In examples such as those of FIGS. 1a-1b, the printing liquid removal element 104 is located, as shown, underneath the collection tray 102 (i.e. displayed along the z direction as shown). The captured printing liquid 116 in such examples may be transported from the collection tray 102 to the printing liquid removal element 104, at least in part, under the force of gravity (acting in the -z direction) acting on the printing liquid 116.

Orientations of elements disclosed herein may be described with respect to the gravity vector g, which defines an upright or vertical position. Thus a plane perpendicular to (normal to) the gravity vector g may be considered to be a horizontal plane. In certain examples such as those of FIGS. 1a-1b, the second surface 102b of the collection tray 102 (as shown, this is the underside of the collection tray 102) is positioned coplanar with a printing liquid receiving surface 104a of the printing liquid removal element 104 (as shown, this is the upper-most side of the printing liquid removal element 104). Having the base 102b of the collection tray 102 oriented horizontally (perpendicular to gravity g) above the printing liquid removal element 104 may help to ensure the waste printing liquid falls completely to the printing liquid removal element 104 for collection and removal.

In certain examples, the second surface 102b of the collection tray may not be positioned coplanar with the printing liquid receiving surface 104a of the printing liquid removal element 104, i.e. it may be tilted away from a plane normal to the gravity vector g. In examples where the second surface 102b of the collection tray 102 is tilted with respect to the printing liquid receiving surface 104a of the printing liquid removal element 104, itself oriented in a plane normal to the gravity vector g, it may be that the collection tray 102 has a trapezoidal cross section in which the first surface 102a of the collection tray 102 is non-parallel with the second surface 102b of the collection tray 102. The first surface 102a of the collection tray 102 may be normal to the gravity vector g and may be co-planar with a substrate 108 to be printed. In such examples, waste printing liquid received in the collection tray 102 may collect under gravity at one side of the second surface 102b for drainage to the printing liquid removal element 104.

In the examples of FIG. 1b, the first surface 102a of the collection tray 102 is positioned coplanar with the second surface 108b of the porous substrate 108. FIG. 1b also shows that the first surface 102a of the collection tray 102 is positioned at a predetermined separation distance 150 from the second surface 108b of the porous substrate 108. In some examples, the predetermined separation distance 150 may be between 2 mm and 10 mm. The predetermined separation distance 150 may be set small enough to mitigate issues caused by the production of aerosol type droplets of waste printing liquid produced at the back/second surface 108b of the substrate 108, which may tend to increase in number as the separation distance increases, and also large enough to mitigate issues caused by the back/second surface of the substrate 108 touching the first surface 102a of the collection tray 102 (and therefore any waste printing liquid present at the first surface 102a of the collection tray 102 which may drag on or stick to the back side 108b of the substrate 108). If either aerosol droplets generated during printing, or printing liquid located on the collection tray, touch the second surface 108b of the porous substrate, they may deposit unwanted marks there which may soil or spoil the appearance of the substrate. It is also desirable to try and minimize the amount of aerosol droplets generated which may soil the substrate and/or the surrounding apparatus.

Various examples allow for printing liquid removal in this way for different printing liquid types, from low viscosity printing liquid (e.g. dye sublimation inks) to high viscosity printing liquid (e.g. latex-based inks). A low viscosity printing liquid may have a viscosity of around 5 cP. A high viscosity printing liquid may have a viscosity of around 50 cP (wherein cP represents centipoise, a measure of the dynamic viscosity of liquid). Further, because the collection tray 102 allows the waste printing liquid 112 to pass through to the printing liquid removal element 104 for removal, no consumable absorbent materials such as foams are to be used. Instead the printing liquid which passes through the porous substrate is driven away e.g. to a waste tank by the printing liquid removal element 104. Thus there is no associated cost of replaceable consumable materials nor the time and labour for replacing such materials, resulting in improved effectiveness as the printer may operate without stopping for the replacement of consumable parts.

Various examples disclosed herein allow for printing liquid waste to be collected into a single recipient container, which may be easy for the printer operator to handle compared with liquid-saturated absorbent materials.

FIG. 2 illustrates a collection tray 102 according to example implementations, positioned for use with a printing liquid removal element 104 below and a porous substrate 108 above as shown. The collection tray 102 comprises a plurality of support ribs 120 in this example, one at either end and just outside of the print zone 148 (i.e. one support rib 120 is located just before the substrate 108 enters into the printing area 148, and another support rib 120 is located just after the printing area 148). Support ribs having a small surface area outside the printing area 148 in contact with a substrate in use are used in some examples. The support ribs 120 are to position the collection tray 102 at a predetermined separation distance 150 from the porous substrate 108 as discussed above (more particularly, the support ribs 120 are to support the second side 108b of the porous substrate 108 at the predetermined separation distance 150 from the first side 102a (which is the printing liquid droplet collection surface 102a) of the collection tray 102. Such support ribs 120 may also reduce sagging of the porous substrate during printing liquid application compared with a similar printing configuration without support ribs. The printer may provide tension to the substrate 108 to keep it straight and flat between support ribs 120. In the printing area 148, if the substrate 108 does not touch any surface nor a support rib, then the substrate is well supported and positioned to avoid marks being left on the back side of the substrate. The support ribs may run parallel to the direction of print head scanning, perpendicular to the direction of print head scanning, or may be oriented at a plurality of different directions (e.g. with respect to the direction of print head scanning). The support ribs 120 may be straight, curved, each have a plurality of straight and/or curved sections, or any other suitable shape to perform the function of maintaining the separation distance 150 and/or supporting the substrate 108. Such a collection tray 102 with ribs may be used in the examples shown in FIGS. 4 and 5.

FIG. 3 shows a composite collection tray according to example implementations. The collection tray 102 in this example comprises a plurality of collection tray modules 102a-f to be positioned together along the length of a print zone 148, in which printing liquid is applied to the porous substrate 108, to form a composite collection tray. In this example six collection tray modules are illustrated but more or fewer than six may be used in other examples. In industrial printers, the size of the print zone may be large, for example between 1.5 m to 5.0 m (in some examples between 1.5 m and 4.0 m). By using a plurality of collection tray modules 102a-f, if a collection tray module 102a-f is to be removed for maintenance, cleaning, or replacement, for example, it may be easier to handle one or more small (e.g. around 0.5 m or e.g. around 1.0 m wide) collection tray modules rather than one single large collection tray 102 with a width matching the print zone width 148. In some examples, such collection tray modules 102a-f may align together via slots, clips, magnets, or any other suitable connection mechanism, with each other and/or with an external support frame (not shown) to help the overall multiple-module collection tray 102 behave as a mechanically stable single collection tray unit 102. Such a modular collection tray 102 may be used in the examples shown in FIGS. 4 and 5.

FIG. 4 shows a printing liquid collection apparatus 100 comprising a closed loop liquid conduit 126 according to example implementations. While the closed loop 126 is illustrated with a schematic single line loop, it may be that there are plural pathways for liquid to flow from the collection tray 102 to the printing liquid removal element 104. The collection tray 102 in this examples contains a transport liquid 130 (for example, water, glycerol) which is miscible with the printing liquid droplets 112. The nature of the transport liquid 130 may be selected according to the printing liquid 112, 114 being used to obtain a good miscibility between the two; for example, if the printing liquid 112, 114 is a viscous vinyl ink, a viscous transport liquid 130 such as glycerol may be suitable.

The transport liquid 130 is to provide the printing liquid droplet collection surface 128. Thus waste printing liquid droplets 114, including aerosol droplets produced by the printing process, reach the surface 128 of the transport liquid 130 and become trapped there through surface tension/wetting interactions. That is, as printing liquid waste droplets and aerosol satellites pass through the porous substrate, they contact the transport liquid surface, causing them to collapse and become trapped in the transport liquid flow. The collection tray 102 may be sealed to help prevent liquid leakages and to help liquid flow from the collection tray 102 through to the printing liquid removal element 104 as part of the liquid flow path. The collection tray 102 may have at least one outlet, or outflow fluid connection, to allow transport liquid 130 to flow 116 from the collection tray 102 to the printing liquid removal element 104. The collection tray 102 may have at least one inlet, or inflow fluid connection, to receive clean transport fluid from the closed transport liquid conduit. In some examples the collection tray may be sealed at the outlet, and/or the inlet, to help prevent liquid leakage at these points in the closed loop transport liquid conduit. In examples using a plurality of modular collection trays 1021-f as in FIG. 3, each modular collection tray 102 may comprise dedicated inlet and outlets. In certain examples, there may be one or more common clean transport liquid inlets for the composite collection tray overall, and/or one or more common dirty transport liquid outlets for the composite collection tray overall. In such examples there may be one of more fluid connections between adjacent collection tray modules 102a-f.

In the example of FIG. 4, the closed loop transport liquid conduit 126 allows for the transport liquid 130 is to flow 116 from the collection tray 102, to the printing liquid removal element 104, and back to the collection tray 102 via the closed loop transport liquid conduit. At different stages in the closed loop transport liquid conduit 126, different levels of waste printing liquid 112 are present mixed with the transport liquid 130. Between the collection tray 102 and the printing liquid removal element 104, a high proportion of printing liquid may be present in the transport liquid 130. After passing out of the printing liquid removal element 104 before reaching the collection tank 106, there may be a low proportion of printing liquid may be present in the transport liquid 130. The waste printing liquid present in the transport liquid 130 may be removed at one or more points in the closed loop transport liquid conduit 126.

For example, in the example of FIG. 4, a filter 122 is present in the closed loop transport liquid conduit 126 between the printing liquid removal element 104 and the collection tray 102. The filter 122 is to separate transport liquid 130 containing printing liquid 112 received from the printing liquid removal element 104 into transport liquid 130 for recirculation to the collection tray 102 and printing liquid for transportation to the waste printing liquid container 106. For example, the filter may be capable of separating liquids of different viscosities. The filtered transport liquid 130 may be transported back to the collection tray 102 by a pump 124 or other suitable liquid transportation mechanism, which may be located in the closed loop transport liquid conduit between the filter 122 and the collection tray 102. One or more filters 122 may be present, for example plural filters may be used to provide staged filtration (e.g. a first rough filtration stage to remove larger blobs or coagulations of printing liquid, followed by a second fine filtration stage to remove smaller droplets of remaining printing liquid). Filters 122 in the system may be replaced or cleaned periodically. One or more pumps 124 may be present to recirculate the filtered transport liquids 130 back to the collection tray 102.

In the examples disclosed here, the printing liquid removal element is to move the collected waste printing liquid 112 away, i.e. to a waste tank/waste printing liquid container 106. This may be termed “active drainage” as the transport liquid is actively pushed through at least the printing liquid removal element of the closed loop transport liquid system. To do so, the printing liquid removal element may comprise a liquid transportation element to drive the captured printing liquid to the waste printing liquid container. Such a liquid transportation element may comprise a movable mechanical element in some examples, such as an Archimedean screw. The Archimedean screw may be rotatable to push transport liquid containing waste printing liquid out of the printing liquid removal element, e.g. towards a filtering unit 122 and/or waste tank 106. The liquid transportation element may comprise a fluidic movement element in some examples, such as a pump to pump the transport liquid containing waste printing liquid out of the printing liquid removal element 104.

By having a continuous flow of transport liquid through the collection tray 102 using the closed loop system 126, filtered clean transport liquid enters the collection tray 102 from the filtering unit 122, while the printing liquid waste is being evacuated through the printing liquid removal element 104, keeping a constant level/height of transport liquid inside the collection tray 102. That is, a constant separation distance 150 may be maintained between the back side of the porous substrate and the transport liquid surface (printing liquid droplet collection 102a). In some examples it may be possible to tune the separation distance 150 by controlling the overall volume of transport liquid in the apparatus 100. In some examples, there may a relationship between the separation distance 150 and the amount of ink deposited during printing (e.g. print mode, or print density), and/or there may be a relationship between the separation distance 150 and the porosity of the substrate 108. The separation distance in such examples may be tuned dependent on such a relationship. It may be desirable to keep the separation distance 150 stable and constant during the printing process in some examples.

In such closed liquid circuit systems as disclosed herein, compared with sticky-belt systems which use water to wash down the sticky belt and remove waste printing liquid, the amount of transport liquid (e.g. water) is much reduced, which is desirable for waste reduction and reducing the environmental impact of disposing of dirty transport liquid/water. Also no adhesives are present for use with the systems described herein.

Such transport liquid systems discussed herein may be capable of operating with a wide range of printing liquid viscosities—i.e. they may be used with highly viscous inks which can be difficult to work with, in particular in foam-based and gutter systems, because high viscosity printing liquids/inks may not be easily absorbed in foams, and gutter systems may get easily clogged. Such transport liquid systems discussed herein may be used with water-based printing liquids, in which case the transport liquid used may be water which is cheap and plentiful. Depending on local regulations, if the transport liquid is to be replaced (e.g. during periodic maintenance of the printer), the transport liquid may be disposed of without onerous special precautions because the concentration of printing liquid in the transport liquid solution can be very low.

FIG. 5 shows a printing liquid collection apparatus 100 comprising a cellular collection tray 102 according to example implementations. The collection tray 102 comprises a plurality of cells 134 separated by cell walls 136, wherein the cell walls 136 are to provide the printing liquid droplet collection surface and provide a path for captured printing liquid 116 to move to the printing liquid removal element 104. As discussed in relation to FIG. 4, the printing liquid removal element 104 may comprise a liquid transportation element to drive the captured printing liquid 118 to a waste printing liquid container 106

The cells 134 in the collection tray 102 may have one or more of: a size, pitch, orientation, and cell wall thickness, dependent on a parameter of the printing liquid applied to the porous substrate. For example, it may be desirable to increase the size of the cells as the viscosity of the printing liquid increases, to help prevent clogging of the cells (while high viscosity liquids may not produce a large amount of aerosol droplets). It may also be desirable to decrease the size of the cells as the viscosity of the printing liquid decreases, because less viscous liquids may produce more aerosol droplets than high viscosity liquids, and a higher cell wall surface area in the collection tray may aid capture of generated aerosol droplets (while lower viscosity liquids are less likely to clog up cells). In some examples, the cell walls may be around 0.1 mm thick. Even in collection trays 102 with larger cell sizes, there is still a high cell wall 136 surface area present which allows aerosol particles to be quickly trapped at the cell wall. Once an aerosol particle touches one a cell wall 136 surface, it collapses to the surface and is no longer able to remain airborne/drift off, but can still flow away from the substrate 108.

In some examples, the cells walls 136 may be at least partially coated or fabricated from a material which provides a low friction surface on which printing liquid droplets which are present on the cell wall can easily slip down under gravity to the printing liquid removal element 104, but which still allows for the printing liquid droplets to readily wet the sell wall surface to capture them and keep them away from the substrate and/or surrounding printing elements. For example, the cells may be coated in a water-repellant coating to help prevent the waste printing liquid from clogging in the cells. In such examples, aerosol droplets may flow down the cell walls under gravity to the printing liquid removal element 104.

In some examples, a collection tray 102 may be a hybrid of the examples discussed in relation to FIGS. 4 and 5, in which a collection tray 102 containing transport liquid 130 for use in a closed loop system may also comprise one or more cell wall 136 structures, wherein both the transport liquid surface and the cell wall structures act as printing liquid droplet collection surfaces to capture printing liquid droplets and channel them away from the substrate being printed.

FIG. 6 shows a schematic plan view (top down view) of an example cellular collection tray 102 according to example implementations. In this example the cells 134 defined by cell walls 136 are hexagonal. Such an arrangement of cells may be called a honeycomb structure. Other possible cell shapes include square, triangular, or curved. Having a high surface area of cell wall 136 may be desirable to increase the area available to capture printing liquid droplets, including aerosol droplets. In some examples, the cell walls 136 may have a thickness below 0.25 mm, for example around 0.1 mm thick. A cell wall thickness may be desirable which is thin enough to provide a large open space in the collection tray 102 into which printing liquid can penetrate and channel through to the printing liquid removal element 104, but which is also thick enough that the cells are not fragile and may break/sag after a short time of use or under the weight of adhered printing liquid. Using a honeycomb structure with hexagonal cells may allow for the use of thin cell walls (e.g. 0.1 mm thick cell walls) which can help prevent printing liquid build up on the top of the cell walls, while obtaining a structurally strong cellular collection tray due to the shape of the cells. That is, honeycomb cells may provide a particularly strong cellular structure. This may be because the hexagonal cell shape provide high structural integrity. A honeycomb cell structure may allow for larger cell/pore sizes than other cell shapes for a given measure of cellular structure strength. The shape, size, pitch, orientation, and/or cell wall 136 thickness of the cells 134 may depend on the type of printing liquid used, so as to mitigate against a build-up of printing liquid under the printing substrate 108 that might generate unwanted marks on the substrate 108, by efficiently channeling the waste printing liquid away from the substrate 108 through the cells 134. For example, different cellular collection trays 102 may be used depending on the nature of the printing liquid being used.

FIGS. 7a-7b show example printing apparatuses 200 comprising a support beam 152 according to example implementations. FIG. 7a shows a schematic cross section through a section of a printer 200 in which a collection tray 102 is mounted on the top of the printer. Waste printing liquid 112 which has passed through the porous printed substrate (not shown) arrives at the printing liquid collection surface of the collection tray 102 and is channeled down to the printing liquid removal element 104, containing a printing liquid removal mechanism 140 (e.g. an Archimedean screw). The collection tray 102 is supported on a support beam 152. The collection tray 102 may be removable so that it can be replaced with another collection tray 102, removed for maintenance/cleaning before replacing the same collection tray 102, or may be replaced with a platen for printing on a non-porous substrate as discussed in relation to FIG. 7b.

FIG. 7b shows a schematic cross section through a section of an example printing apparatus 200 as in FIG. 7a. The printer 200 comprises the support beam 152 as before. However, the collection tray 102 has been replaced with a (removable) platen 154. The printer may then be used as a vacuum-assisted platen printer, whereby a vacuum connection 156 between the platen and the vacuum chamber 158 maintains a vacuum to bring the overlying non-porous substrate/media 180 onto the platen for printing with printing liquid. The arrows at the vacuum connections 156 indicate the direction of airflow. The printing liquid removal element 104 may remain in place, with any mechanism used therein 140 for collecting waste printing liquid arising from printing on a porous substrate 108.

Thus the same printer 200 may be provided which is versatile and can be used with both porous 108 and non-porous 180 substrates. To print on porous substrates 108 such as textiles, a collection tray 102 may be used as in FIG. 7a. To switch to non-porous printing collection tray 102 can be uninstalled from the print-zone, and then replaced by a platen (or plural platen modules) 154. Both the platen (modules) 154 and the collection tray (modules) 102 may have the same mechanical interfaces with the structural beam 152 to allow them to be removably fixed in place on the structural beam 152 for printing. However, while the collection tray (modules) 102 connects with the printing liquid removal element 104, the platen (modules) 154 do not. The platen (modules) 154 connect with the vacuum cavity 158 of the structure beam 152 instead, since the non-porous media 180 use vacuum to control their shape during the printing process.

Examples disclosed herein may provide for printing on a porous substrate without using a consumable printing liquid capture system such as a foam based system, which reduces material costs and reduces the environmental impact of printing since no printing liquid saturated foams are to be safely disposed of, and allows for fewer interruptions to printing due to replacing consumable parts. Collecting the waste printing liquid in a container 106 may be easier to handle for disposal than a printing liquid-soaked foam or blanket.

In examples in which a removable collection tray (or tray modules) for porous substrate printing and platen (or platen modules) for non-porous substrate printing may be used with the same printer, both the platen modules and the collection tray modules may have the same height (dimension in the z direction as shown in the Figures) and interfaces (to connect to the printer) when assembled on the same structure beam. In such cases, it may be that there is no large travel distance over which the printing carriage is raised in order to switch between both printing modes (porous and non-porous). Therefore, it may be that no lifter subsystem is used for this printing carriage lifting purpose, thereby the overall printing apparatus is mechanically simpler than a system using a lifter subsystem. Moreover, keeping a unique carriage printing height may alow for improved control on the printhead-to-paper-spacing 160 (i.e. the distance between the printhead's 110 nozzle to the substrate 108 surface 108a being printed), which in turn may result in a more consistent printed image quality.

FIG. 8 shows an example method 800 of according to example implementations. The method 800 comprises applying a printing liquid to a porous substrate supported on a collection tray, the collection tray comprising a printing liquid droplet collection surface 802; capturing, by the printing liquid droplet collection surface of the collection tray, printing liquid droplets produced during application of the printing liquid to the porous substrate 804; and channeling the captured printing liquid droplets away from the porous substrate 806. Channeling the captured printing liquid droplets away from the porous substrate 806 may comprise channeling the captured printing liquid droplets to a printing liquid removal element 806a; and transporting, by the printing liquid removal element, the captured printing liquid to a waste printing liquid container 806b.

It will be appreciated that examples disclosed herein which focus on a particular feature without discussion in detail of other features may be combinable with another particular examples disclosed focusing on a different particular feature. For example, any of the examples disclosed herein may use either a single collection tray or a composite collection tray comprising a plurality of modular collection trays. As another example, any suitable waste printing liquid removal mechanism may be used with any collection tray arrangement (e.g. containing a transport liquid, or a cellular collection tray). As another example, any disclosed collection tray may or may not comprise support ribs.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context suggests otherwise. In particular, where the indefinite article is used, the specification is to be understood as contemplating plurality as well as singularity, unless the context suggests otherwise.

1. A printing liquid collection apparatus comprising:
a collection tray comprising a printing liquid droplet collection surface to capture printing liquid droplets produced during application of a printing liquid to a porous substrate; and
a printing liquid removal element to receive the captured printing liquid from the collection tray and transport the captured printing liquid to a waste printing liquid container.

2. The printing liquid collection apparatus of claim 1, wherein the collection tray is to be located between the porous substrate and the printing liquid removal element during application of the printing liquid to the porous substrate.

3. The printing liquid collection apparatus of claim 2, wherein:
the collection tray is to be located to receive the printing liquid droplets at a first surface of the collection tray, from a second surface of the porous substrate, during application of the printing liquid to a first surface of the porous substrate, wherein the first surface of the porous substrate is opposite the second surface of the porous substrate; and
the printing liquid removal element is to receive the captured printing liquid from a second surface of the collection tray, wherein the first surface of the collection tray is opposite the second surface of the collection tray.

4. The printing liquid collection apparatus of claim 3, wherein the first surface of the collection tray is to be positioned coplanar with, and at a predetermined separation distance from, the second surface of the porous substrate.

5. The printing liquid collection apparatus of claim 4, wherein the collection tray comprises a plurality of support ribs to position the collection tray at the predetermined separation distance from the porous substrate.

6. The printing liquid collection apparatus of claim 1, wherein the collection tray contains a transport liquid miscible with the printing liquid droplets, the transport liquid to provide the printing liquid droplet collection surface and flow from the collection tray to the printing liquid removal element.

7. The printing liquid collection apparatus of claim 6, comprising a closed loop transport liquid conduit, wherein the transport liquid is to flow from the collection tray, to the printing liquid removal element, and back to the collection tray via the closed loop transport liquid conduit.

8. The printing liquid collection apparatus of claim 7, comprising a filter in the closed loop transport liquid conduit between the printing liquid removal element and the collection tray, the filter to separate transport liquid containing printing liquid received from the printing liquid removal element into transport liquid for recirculation to the collection tray and printing liquid for transportation to the waste printing liquid container.

9. The printing liquid collection apparatus of claim 1, wherein the collection tray comprises a plurality of cells separated by cell walls, wherein the cell walls are to provide the printing liquid droplet collection surface and provide a path for captured printing liquid to move to the printing liquid removal element.

10. The printing liquid collection apparatus of claim 9, wherein the cells have one or more of: a size, pitch, orientation, and cell wall thickness, dependent on a parameter of the printing liquid applied to the porous substrate.

11. The printing liquid collection apparatus of claim 1, wherein the printing liquid removal element comprises a liquid transportation element to drive the captured printing liquid to the waste printing liquid container.

12. The printing liquid collection apparatus of claim 1, wherein the collection tray comprises a plurality of collection tray modules to be positioned together along the length of a print zone, in which printing liquid is applied to the porous substrate, to form a composite collection tray.

13. A printer comprising:
a printing liquid collection apparatus; and
a structural beam to support the collection tray,
the printing liquid collection apparatus comprising:
a collection tray comprising a printing liquid droplet collection surface to capture printing liquid droplets produced during application of a printing liquid to a porous substrate, and
a printing liquid removal element to receive the captured printing liquid from the collection tray and transport the captured printing liquid to a waste printing liquid container.

14. A method comprising:
applying a printing liquid to a porous substrate supported on a collection tray, the collection tray comprising a printing liquid droplet collection surface;
capturing, by the printing liquid droplet collection surface of the collection tray, printing liquid droplets produced during application of the printing liquid to the porous substrate; and
channeling the captured printing liquid droplets away from the porous substrate.

15. The method of claim 14, wherein channeling the captured printing liquid droplets away from the porous substrate comprises:
channeling the captured printing liquid droplets to a printing liquid removal element; and
transporting, by the printing liquid removal element, the captured printing liquid to a waste printing liquid container.
